(19) United States
(12) Patent Application Publication
(10) Pub. No.: US 2010/0050483 A1
(43) Pub. Date: Mar. 4, 2010

(54) APPARATUS WITH FASTENING DEVICE

(75) Inventors: FANG-KENG HSIEH, Tu-Cheng (TW); DONG-WEI ZHAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen)CO.,LTD., ShenZheng City (CN); HON HAI PRECISION INDUSTRY CO.,LTD., Tu-Cheng (TW)

(21) Appl. No.: 12/534,877

(22) Filed: Aug. 4, 2009

(30) Foreign Application Priority Data
Aug. 29, 2008 (CN) 200810304286.7

(51) Int. Cl. G09F 19/00

(52) U.S. Cl. 40/1

(57) ABSTRACT

A display device includes a glass sheet, a front frame, and a fastening device. The glass sheet is used for protecting a display module disposed in an enclosure of the display device. The front frame is a part of the enclosure of the display device. The fastening device has a first surface and a second surface opposite to the first surface. The first surface is glued to the glass sheet with adhesive. The second surface is detachedly attached to the front frame.

### BACKGROUND

1. Technical Field

The present disclosure relates to fastening technologies, and particularly to an apparatus with a fastening device to assemble two independent components together.

2. Description of Related Art

A typical display includes a display module, a glass sheet and a front frame. The glass sheet is placed in front of the display module to protect the display module. Both of the display module and the glass sheet are attached to the front frame. The glass sheet may be firmly glued to the front frame with adhesive.

If, after gluing, the glass sheet is damaged and needs to be removed or detached from the front frame, it may not be convenient to do this because of the firm or strong adhesive bonding between the glass sheet and the front frame. As a result the combination of the glass sheet and the front frame may have to be replaced. This is expensive.

Therefore, there is room for improvement within the art; an apparatus with a new fastening device is desired.

### BRIEF DESCRIPTION OF THE DRAWINGS

FIG. 1 is an isometric view of an apparatus in accordance with an exemplary embodiment.

FIG. 2 is a partially exploded view of the apparatus in FIG. 1 from one direction.

FIG. 3 is a partially exploded view of the apparatus in FIG. 1 from a reverse direction to FIG. 2.

FIG. 4 is an enlarged view of a circled portion IV of FIG. 2.

### DETAILED DESCRIPTION

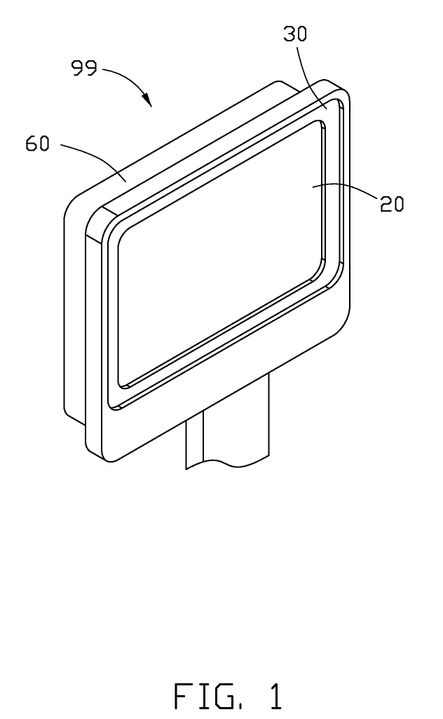

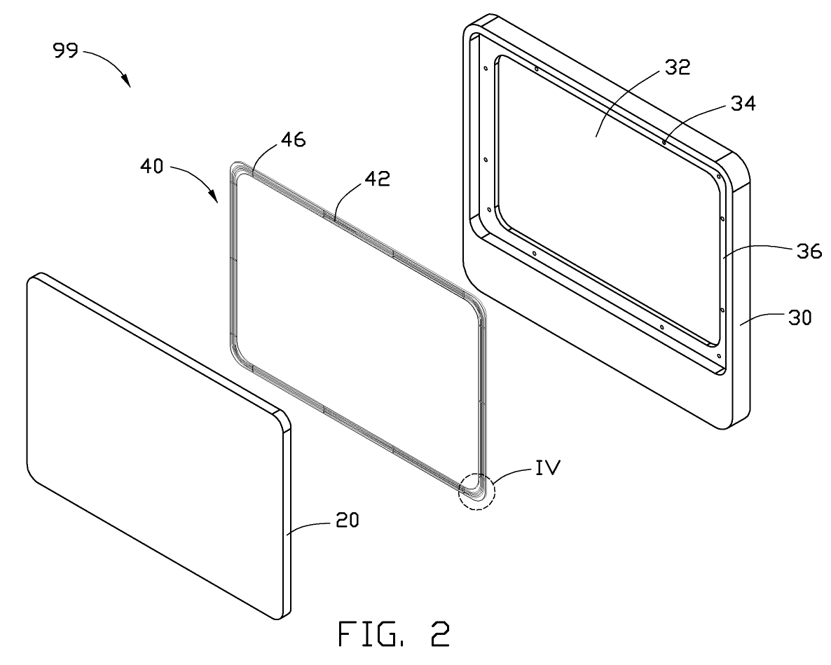

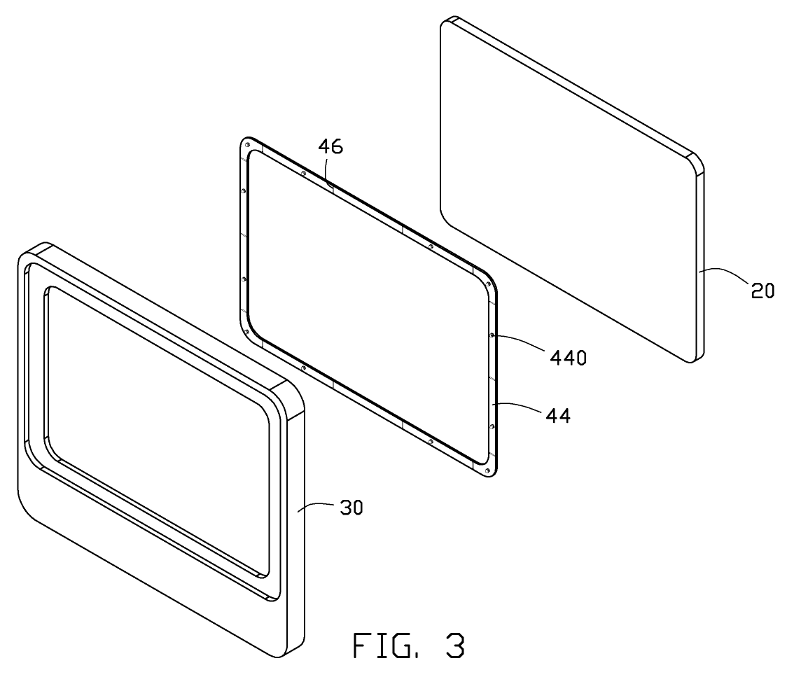

Referring to FIGS. 1 to 3, an apparatus 99 includes a glass sheet 20, a frame 30, and a fastening device 40 attaching the glass sheet 20 to the frame 30. The apparatus 99 may be a display device.

The frame 30 may be a part of an enclosure 60 of the apparatus 99, such as a front frame of a display device. The frame 30 defines a rectangular receiving portion 36 in a rear surface of the frame 30. The receiving portion 36 defines a rectangular opening 32 for providing a viewable window, and a plurality of latch holes 34 around the opening 32.

The glass sheet 20 may be used for protecting components (not labeled), such as a display module, received in the enclosure 60 of the apparatus 99. A shape of the glass sheet 20 can be predetermined according to requirements of the frame 30. In this embodiment, the glass sheet 20 is substantially rectangular. In another embodiment, the glass sheet 20 may be substantially circular.

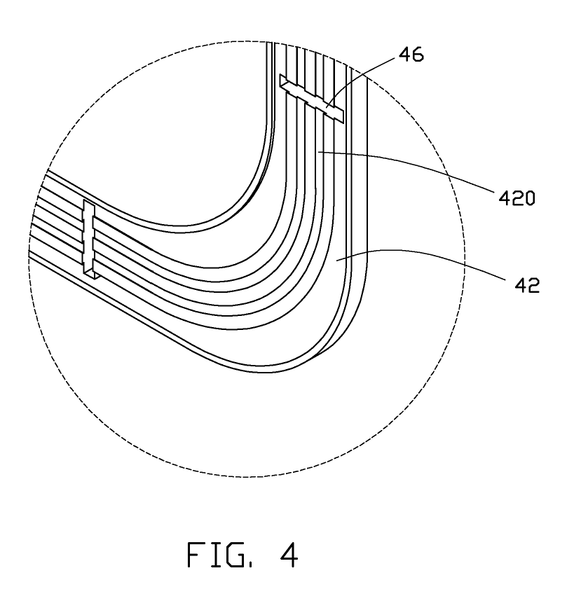

The fastening device 40 is used for attaching the glass sheet 20 to the receiving portion 36 of the frame 30. The fastening device 40 may includes a frame having two surfaces on opposite sides of the fastening device 40, e.g. a first surface 42, a second surface 44. A plurality of through holes 46 are defined in the fastening device 40 communicating between the first surface 42 and the second surface 44. A shape of the fastening device 40 corresponds to the shape of the glass sheet 20. In this embodiment, the fastening device 40 is substantially rectangular. Referring to FIG. 4, the first surface 42 defines a plurality of channels 420. The channels 420 are parallel with each other and communicate with the through holes 46. The second surface 44 has a plurality of latching protrusions 440 corresponding to the latch holes 34 in the frame 30.

In assembly, the first surface 42 of the fastening device 40 is held against the edges of the glass sheet 20. The channels 420 are applied with adhesive at the through holes 46, the first surface 42 is thus adhered to the glass sheet 20 with the adhesive, thereby, yielding a sub-assembly of the glass sheet 20 and the fastening device 40. In addition, excess adhesive flows in the channels 420 away from the through holes 46 to prevent the adhesive from overflowing out of the through holes 46.

Then, the sub-assembly is attached to the receiving portion 36 of the frame 30. The latching protrusions 440 are inserted into the latch holes 34 correspondingly to removably attach the fastening device 40 with the frame 30, thus the glass sheet 20 is detachedly fastened to the frame 30. The glass sheet 20 is partially exposed out of the frame 30 via the opening 32. If the glass sheet 20 needs to be detached from the frame 30 due to defects or damages during manufacturing or while in use, the glass sheet 20 can be conveniently detached from the frame 30, the frame 30 need not be replaced together with the glass sheet 20.

The fastening device 40 may be made of rubber, thus the glass sheet 20 is hermetically attached to the frame 30 to prevent dust from entering into the enclosure 60 of the apparatus 99.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A display device comprising:
a front frame being part of an enclosure of the display device;
a glass sheet for protecting a display module arranged in the enclosure of the display device; and
a fastening device having a first surface and a second surface opposite to the first surface, the first surface being glued to the glass sheet with adhesive; the second surface being detachedly attached to the front frame.

2. The display device according to claim 1, wherein the front frame defines a plurality of latch holes; the second surface has a plurality of latching protrusions thereon; and the latching protrusions are insertable into the corresponding latch holes to detachedly attach the glass sheet to the front frame.

3. The display device according to claim 2, wherein the front frame defines an opening for partially exposing the glass sheet outside, and the plurality of latch holes are arranged around the opening.

4. The display device according to claim 1, wherein the fastening device defines at least one through hole communicating between the first surface and the second surface for guiding the adhesive between the glass sheet and the first surface.

5. The display device according to claim 4, wherein the first surface has at least one channel communicating with the at least one through hole for receiving the adhesive.

6. The display device according to claim 1, wherein the fastening device is made of rubber.

7. An apparatus comprising:
a glass sheet for protecting components arranged in an enclosure of the apparatus;
a frame as a part of the enclosure of the apparatus; and
a fastening device having a first surface and a second surface opposite to the first surface, the first surface being glued to the glass sheet with adhesive; the second surface being detachedly attached to the frame.

8. The apparatus according to claim 7, wherein the frame defines a plurality of latch holes; the second surface has a plurality of latching protrusions thereon; and the latching protrusions are insertable into the corresponding latch holes to detachedly attach the glass sheet to the frame.

9. The apparatus according to claim 8, wherein the frame defines an opening for partially exposing the glass sheet outside, and the plurality of latch holes are arranged around the opening.

10. The apparatus according to claim 7, wherein the fastening device defines at least one through hole communicating between the first surface and the second surface for guiding the adhesive between the glass sheet and the first surface.

11. The apparatus according to claim 10, wherein the first surface has at least one channel communicating with the at least one through hole for receiving the adhesive.

12. The apparatus according to claim 7, wherein the fastening device is made of rubber.

13. An apparatus comprising:
a glass sheet;
a frame as a part of an enclosure of the apparatus; and
a fastening device having a first surface attached to the glass sheet and a second surface opposite to the first surface, the second surface being detachedly attached to the frame.

14. The apparatus according to claim 13, wherein the frame defines a plurality of latch holes; the second surface has a plurality of latching protrusions thereon; and the latching protrusions are insertable into the corresponding latch holes to detachedly attach the glass sheet to the frame.

15. The apparatus according to claim 14, wherein the frame defines an opening for partially exposing the glass sheet outside, and the plurality of latch holes are around the opening.

16. The apparatus according to claim 13, wherein the first surface is glued to the glass sheet with adhesive.

17. The apparatus according to claim 16, wherein the fastening device defines at least one through hole communicating between the first surface and the second surface for guiding the adhesive between the glass sheet and the first surface.

18. The apparatus according to claim 16, wherein the first surface has at least one channel for receiving the adhesive.

19. The apparatus according to claim 13, wherein the fastening device is made of rubber.
